(19) United States
(12) Patent Application Publication
(10) Pub. No.: US 2022/0058489 A1
(43) Pub. Date: Feb. 24, 2022

(54) TWO-HEADED ATTENTION FUSED AUTOENCODER FOR CONTEXT-AWARE RECOMMENDATION

(71) Applicant: THE TORONTO-DOMINION BANK, TORONTO (CA)

(72) Inventors: Maksims Volkovs, Toronto (CA); Juan Felipe Vallejo, Toronto (CA); Jin Peng Zhou, Toronto (CA); Zhaoyue Cheng, Toronto (CA)

(21) Appl. No.: 17/405,939

(22) Filed: Aug. 18, 2021

Related U.S. Application Data
(60) Provisional application No. 63/067,862, filed on Aug. 19, 2020.

(51) Int. Cl. G06N 3/08; G06N 3/04

(52) U.S. Cl. CPC G06N 3/084; G06N 3/0472; G06N 3/088

(57) ABSTRACT

A recommendation system uses a trained two-headed attention fused autoencoder to generate likelihood scores indicating a likelihood that a user will interact with a content item if that content item is suggested or otherwise presented to the user. The autoencoder is trained to jointly learn features from two sets of training data, including user review data and implicit feedback data. One or more fusion stages generate a set of fused feature representations that include aggregated information from both the user reviews and user preferences. The fused feature representations are inputted into a preference decoder for making predictions by generating a set of likelihood scores. The system may train the autoencoder by including an additional NCE decoder that further helps with reducing popularity bias. The trained parameters are stored and used in a deployment process for making predictions, where only the reconstruction results from the preference decoder are used as predictions.

### CROSS REFERENCE TO RELATED APPLICATIONS

This application claims the benefit of U.S. Provisional Application No. 63/067,862, filed Aug. 19, 2020, which is incorporated by reference herein in its entirety.

### BACKGROUND

This invention relates generally to generating recommendations, and more particularly to generating recommendations for users of online systems.

Online systems manage and provide various items to users of the online systems for users to interact with. As users interact with the content items, users may express or reveal preferences for some items over others. The items may be entertainment content items, such as videos, music, or books, or other types of content, such as academic papers, electronic commerce (e-commerce) products. It is advantageous for many online systems to include recommendation systems that suggest relevant items to users for consideration. Recommendation systems can increase frequency and quality of user interaction with the online system by suggesting content a user is likely to be interested in or will interact with.

In general, models for recommendation systems use preference information between users and items of an online system to predict whether a particular user will like an item. Items that are predicted to have high preference for the user may then be suggested to the user for consideration. However, recommendation systems may often be skewed by popular items, causing recommendation systems to over- or under-recommend content items that have more or fewer total evaluations. Accordingly, there is a need for recommendation systems to generate more effective recommendations by leveraging more personalized information related to each user such that the recommendation system generates personalized recommendations for each individual user instead of recommending popular items.

### SUMMARY

A recommendation system generates recommendations for users of an online system. The recommendation system uses a trained two-headed attention fused autoencoder to generate likelihood scores indicating a likelihood that a user will interact with a content item if that content item is suggested or otherwise presented to the user. The two-headed attention fused autoencoder is trained to jointly learn features from two sets of training data, including user review data and implicit feedback data (e.g. user-item interaction data). A review encoder may embed the review data into a set of review feature vectors, and a preference encoder may embed the implicit feedback data into a set of preference feature vectors. The set of review feature vectors and the set of preference feature vectors may be fused through an early fusion stage and a late fusion stage. The early fusion stage and the late fusion stage may leverage one or more attention mechanisms that assign weights to words in a review, assign weights to reviews generated by a user, and assign weights to different modalities (e.g. preference input data and review input data). The fusion stages generate a set of fused feature representations that include aggregated information from both the user reviews and user preferences.

The fused feature representations may be inputted into a preference decoder for making predictions by generating a set of likelihood scores indicating a likelihood that each user will interact with an item that is presented to the user. The recommendation system may train the two-headed attention fused autoencoder by including an additional NCE decoder (Noise Contrastive Estimation) that further helps with reducing popularity bias. During the training process, the NCE decoder may increase recommendation likelihoods for items with observed interactions instead of increasing likelihoods based on popularity of items. The recommendation system may iteratively perform a forward pass that generates an error term based on one or more loss functions, and a backpropagation step that backpropagates gradients for updating a set of parameters. The recommendation system may stop the iterative process when a predetermined criterion is achieved. The trained parameters are stored and used in a deployment process for making predictions, where only the reconstruction results from the preference decoder are used as predictions.

The disclosed recommendation system provides multiple advantageous technical features. For example, the disclosed recommendation system generates personalized recommendations by reducing popularity bias that over-recommends popular items. Specifically, the disclosed recommendation system uses a Noise Contrastive Estimation (NCE) decoder in a two-headed decoder architecture to de-popularize the bias as observed in existing recommendation systems. Furthermore, the disclosed recommendation system generates effective recommendations using both implicit feedback and user reviews. The disclosed recommendation system extracts information from user generated reviews, which contain a rich source of preference information, often with specific details that are important to each user and can help mitigate the popularity bias. Additionally, the disclosed recommendation system effectively correlates meaningful information between observed preferences and reviews by training a neural network that jointly learns representations from both user reviews and implicit feedback data using an early fusion stage and a late fusion stage. The two fusion stages further leverage one or more attention mechanisms that are helpful in fusing information extracted from reviews and implicit feedback data in a meaningful way. The fused representations are then used to generate personalized and effective recommendations.

### BRIEF DESCRIPTION OF THE DRAWINGS

FIG. 1 depicts an exemplary system environment including a recommendation system, in accordance with one embodiment.

FIG. 2 depicts an exemplary deployment process for generating recommendations based on implicit feedback data and user review data, in accordance with one embodiment.

FIG. 3 depicts an exemplary embodiment of a preference encoder, in accordance with one embodiment.

FIG. 4 depicts an exemplary embodiment of a review encoder, in accordance with one embodiment.

FIG. 5 depicts an exemplary embodiment of an early fusion module of the review encoder, in accordance with one embodiment

FIG. 6 depicts an exemplary embodiment of a late fusion process, in accordance with one embodiment.

FIG. 7 depicts an exemplary training process for generating recommendations based on implicit feedback data and user review data, in accordance with one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Overview

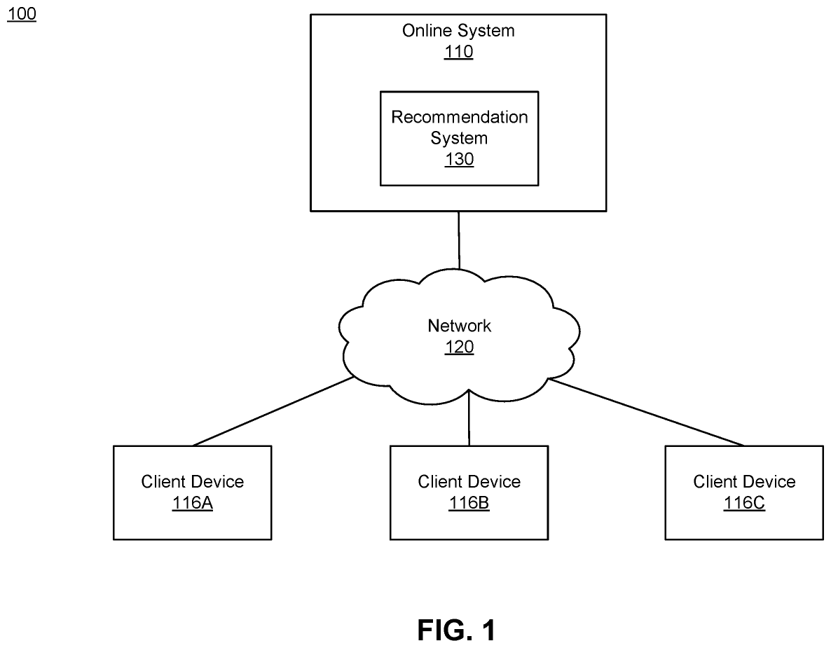

FIG. 1 is a high-level block diagram of a system environment for a recommendation system 130, in accordance with an embodiment. The system environment 100 shown by FIG. 1 includes one or more client devices 116, a network 120, and an online system 110 that includes a recommendation system 130. In alternative configurations, different and/or additional components may be included in the system environment 100.

The online system 110 manages and provides various items to users of the online systems for users to interact with. For example, the online system 110 may be a video streaming system, in which items are videos that users can upload, share, and stream from the online system 110. As another example, the online system 110 may be an e-commerce system, in which items are products for sale, and sellers and buyers can browse items and perform transactions to purchase products. As another example, the online system 110 may be article directories, in which items are articles from different topics, and users can select and read articles that are of interest.

The recommendation system 130 identifies relevant items that users are likely to be interested in or will interact with and suggests the identified items to users of the online system 110. It is advantageous for many online systems 110 to suggest relevant items to users because this can lead to increase in frequency and quality of interactions between users and the online system 110, and help users identify more relevant items. The recommendation system 130 may generate recommendations that are personalized for each user based on both implicit feedback (e.g. user-item interactions) and user-generated reviews. For example, a recommendation system 130 included in a video streaming server may identify and suggest movies that a user may like based on movies that the user has previously viewed and based on the historical reviews generated by the user. Specifically, the recommendation system 130 may identify such relevant items based on preference information received from users as they interact with the online system 110. The preference information contains preferences for some items by a user over relative to other items. The preference information may be explicitly given by users, for example, through a rating survey that the recommendation system 130 provides to users, and/or may be deduced or inferred by the recommendation system 130 from actions of the user. Depending on the implementation inferred preferences may be derived from many types of actions, such as those representing a user's partial or full interaction with a content item (e.g., consuming the whole item or only a portion), or a user's action taken with respect to the content item (e.g., sharing the item with another user).

The recommendation system 130 uses machine learning models to predict whether a particular user will like an item based on preference information. Items that are predicted to have high preference by the user may then be suggested to the user for consideration. The recommendation system 130 may have millions of users and items of the online system 110 for which to generate recommendations and expected user preferences and may also receive new users and items for which to generate recommendations. Moreover, preference information is often significantly sparse because of the very large number of content items. Thus, the recommendation system 130 generates recommendations for both existing and new users and items based on incomplete or absent preference information for a very large number of the content items.

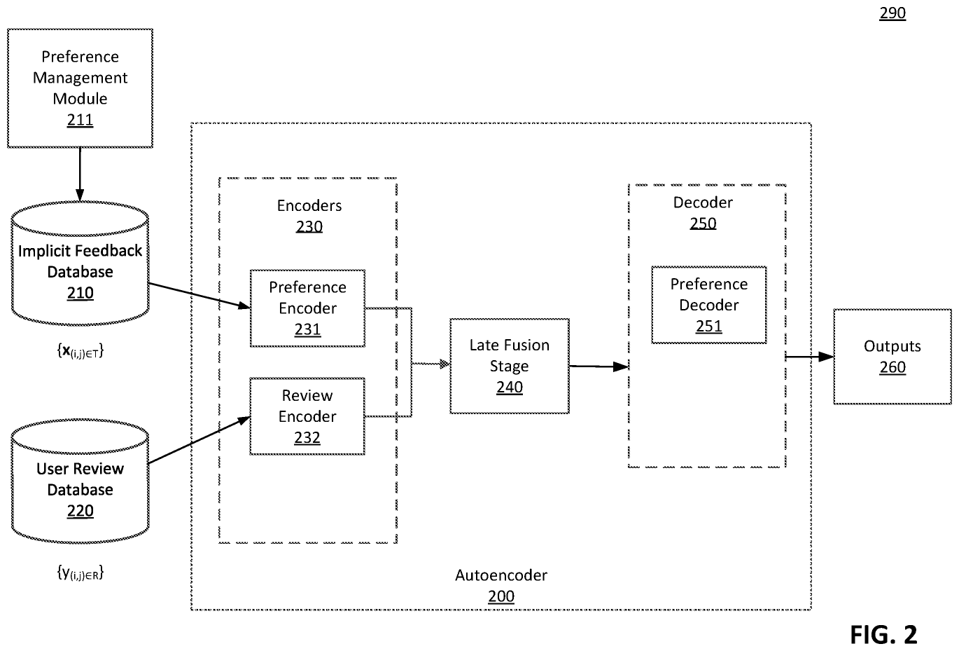

In one embodiment, the recommendation system 130 may generate recommendations for the online system 110 by using a trained deep neural network. The deep neural network may be a two-headed attention fused deep neural network that jointly learns features from user reviews and implicit feedback to make recommendations and de-popularizes user representations via a two-headed decoder architecture. The two-headed decoder architecture includes an NCE decoder that increases recommendation likelihood for items with observed interactions instead of increasing likelihood based on popularity of items. Stated another way, the two-headed attention fused model uses a specific architecture to reduce the effect of content items that are highly popular to reduce the likelihood that these items are recommended at a higher frequency than their actual observed interactions with a user. The recommendation system 130 may further generate effective recommendations by leveraging user-generated reviews which may provide additional preference details specific to each user for generating more personalized and effective recommendations. The recommendation system 130 is discussed in further details below in accordance with FIGS. 2-7.

The client devices 116 are computing devices that display information to users and communicates user actions to the online system 110. While three client devices 116A, 116B, 116C are illustrated in FIG. 1, in practice many client devices 116 may communicate with the online system 110 in environment 100. In one embodiment, a client device 116 is a conventional computer system, such as a desktop or laptop computer. Alternatively, a client device 116 may be a device having computer functionality, such as a personal digital assistant (PDA), a mobile telephone, a smartphone or another suitable device. A client device 116 is configured to communicate via the network 120, which may comprise any combination of local area and/or wide area networks, using both wired and/or wireless communication systems.

In one embodiment, a client device 116 executes an application allowing a user of the client device 116 to interact with the online system 110. For example, a client device 116 executes a browser application to enable interaction between the client device 116 and the online system 110 via the network 120. In another embodiment, the client device 116 interacts with the online system 110 through an application programming interface (API) running on a native operating system of the client device 116, such as IOS® or ANDROID™.

The client device 116 allows users to perform various actions on the online system 110 and provides the action information to the recommendation system 130. For example, actions information for a user may include a list of items that the user has previously viewed on the online system 110, search queries that the user has performed on the online system 110, items that the user has uploaded on the online system 110, and the like. Action information may also include information on user actions performed on third party systems. For example, a user may purchase products on a third-party website, and the third-party website may provide the recommendation system 130 with information on which user performed the purchase action.

The client device 116 can also provide social information to the recommendation system 130. For example, the user of a client device 116 may permit the application of the online system 110 to gain access to the user's social network profile information. Social information may include information on how the user is connected to other users on the social networking system, the content of the user's posts on the social networking system, and the like. In addition to action information and social information, the client device 116 can provide other types of information, such as location information as detected by a global positioning system (GPS) on the client device 116, to the recommendation system 130.

In one embodiment, the client devices 116 also allow users to rate items and provide preference information on which items the users prefer over the other. For example, a user of a movie streaming system may complete a rating survey provided by the recommendation system 130 to indicate how much the user liked a movie after viewing the movie. In some embodiments, the ratings may be a zero or a one (indicating interaction or no interaction), although in other embodiments the ratings may vary along a range. For example, the survey may request the user of the client device 116B to indicate the preference using a binary scale of “dislike” and “like,” or a numerical scale of 1 to 5 stars, in which a value of 1 star indicates the user strongly disliked the movie, and a value of 5 stars indicates the user strongly liked the movie. However, many users may rate only a small proportion of items in the online system 110 because, for example, there are many items that the user has not interacted with, or simply because the user chose not to rate items.

Preference information is not necessarily limited to explicit user ratings and may also be included in other types of information, such as action information, provided to the recommendation system 130. For example, a user of an e-commerce system that repeatedly purchases a product of a specific brand indicates that the user strongly prefers the product, even though the user may not have submitted a good rating for the product. As another example, a user of a video streaming system that views a video only for a short amount of time before moving onto the next video indicates that the user was not significantly interested in the video, even though the user may not have submitted a bad rating for the video.

The client devices 116 also receive item recommendations for users that contain items of the online system 110 that users may like or be interested in. The client devices 116 may present recommendations to the user when the user is interacting with the online system 110, as notifications, and the like. For example, video recommendations for a user may be displayed on portions of the website of the online system 110 when the user is interacting with the website via the client device 116. As another example, client devices 116 may notify the user through communication means such as application notifications and text messages as recommendations are received from the recommendation system 130.

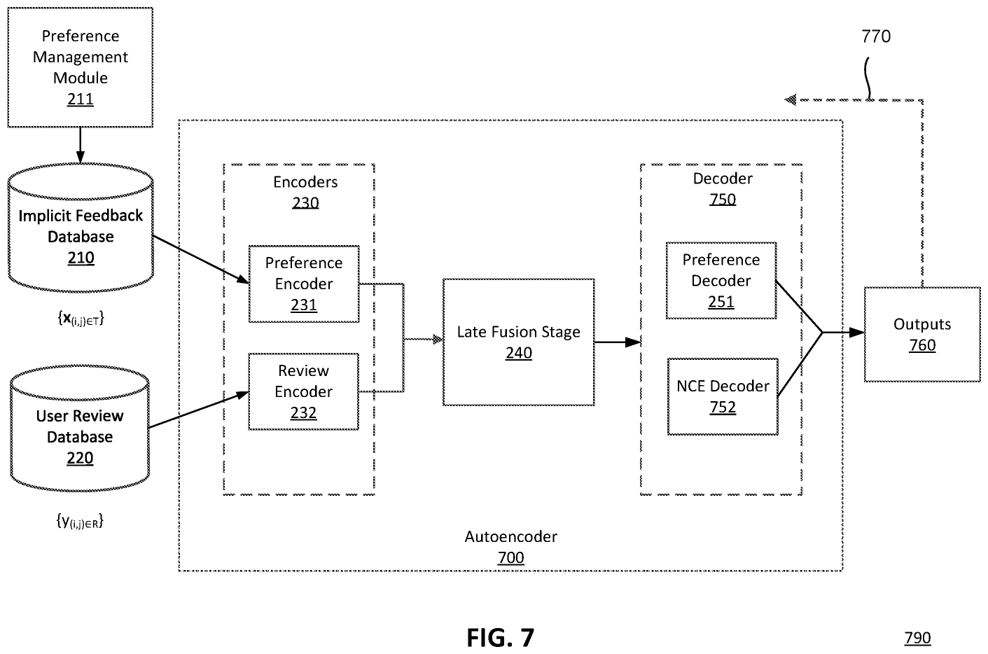

FIG. 2 illustrates an exemplary prediction model 290 for generating personalized recommendations for a user based on user reviews and implicit feedback data. Specifically, FIG. 2 illustrates an exemplary deployment process using the prediction model after the training process for the prediction model has been completed. The training process is discussed in more detail in conjunction with FIG. 7.

In the exemplary architecture illustrated in FIG. 2, the prediction model 290 receives input data from implicit feedback database 210 and user review database 220, where the implicit feedback data are generated by preference management module 211. The prediction model 290 passes the input data to autoencoder 200 and generates outputs 260. The autoencoder 200 comprises encoders 230 including a preference encoder 231 and a review encoder 232. The autoencoder 200 further includes a late fusion stage 240, and a decoder 250 which includes a preference decoder 251. In alternative configurations, different and/or additional components may be included in the system environment 100. The functionalities of the different parts of the prediction model 290 is discussed in further details below.

Preference management module 211 may manage implicit feedback data indicating user preference for users of the online system 110. Specifically, the preference management module 211 may manage interaction data between each user-item pair for a set of n users U=u₁, u₂, . . . , uₙ and a set of m items V=v₁, v₂, . . . , vₘ of the online system 110. In one embodiment, the preference management module 211 represents the preference information as a matrix containing user-item interaction information and stores the preference information in the implicit feedback database 210. The implicit feedback database 210 may store a matrix array R of elements consisting of n rows and m columns, in which each row u corresponds to user u, and each column v corresponds to item v. Each element in the matrix R(u, v) corresponds to a rating value that numerically indicates the preference of user u for item v based on a predetermined scale. In an example, the rating matrix is a Boolean value of zero or one, in which a one represents a preference or an interaction of a user with a content item, and a value of zero represents either no preference or no interaction with the content item. In other embodiments, the ratings may have different ranges. Since the number of users and items may be significantly large, and ratings may be unknown for many users and items, the implicit feedback database 210 is, in general, a high-dimensional sparse matrix. Though described herein as a matrix, the actual structural configuration of the implicit feedback database 210 may vary in different embodiments to alternatively describe the preference information. As an example, user preference information may instead be stored for each user as a set of preference values for specified items. These various alternative representations of preference information may be similarly used for the analysis and preference prediction described herein.

The user review database 220 stores textual reviews generated by users. Each review may include a sequence of words. Each user may be associated with one or more reviews generated by the user, and the one or more reviews may correspond to one or more items. Each review may provide information implying preference information of the user or implying details about the items. Specifically, each user uᵢ may correspond to a sequence of reviews S₁, S₂, . . . , S_{P}, and each review S may be tokenized into word tokens t₁, t₂, . . . , tₛ, where each word token t may refer to a tokenized word (e.g. a word or term without punctuations) in a review. The reviews generated by a user may contain both relevant reviews and noisy reviews that may not provide information that is as meaningful as the relevant reviews. In practice users can have a large number of reviews (e.g., hundreds or even thousands). In one embodiment, a subset of the most recent reviews is sampled and used as input data because the most recent reviews are more likely to convey the latest user preference.

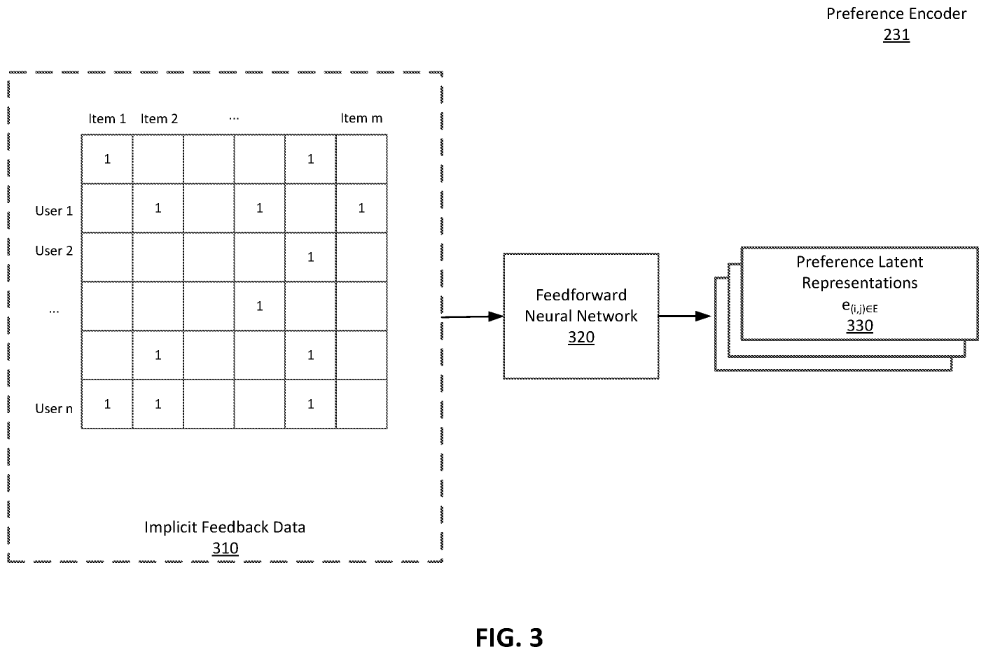

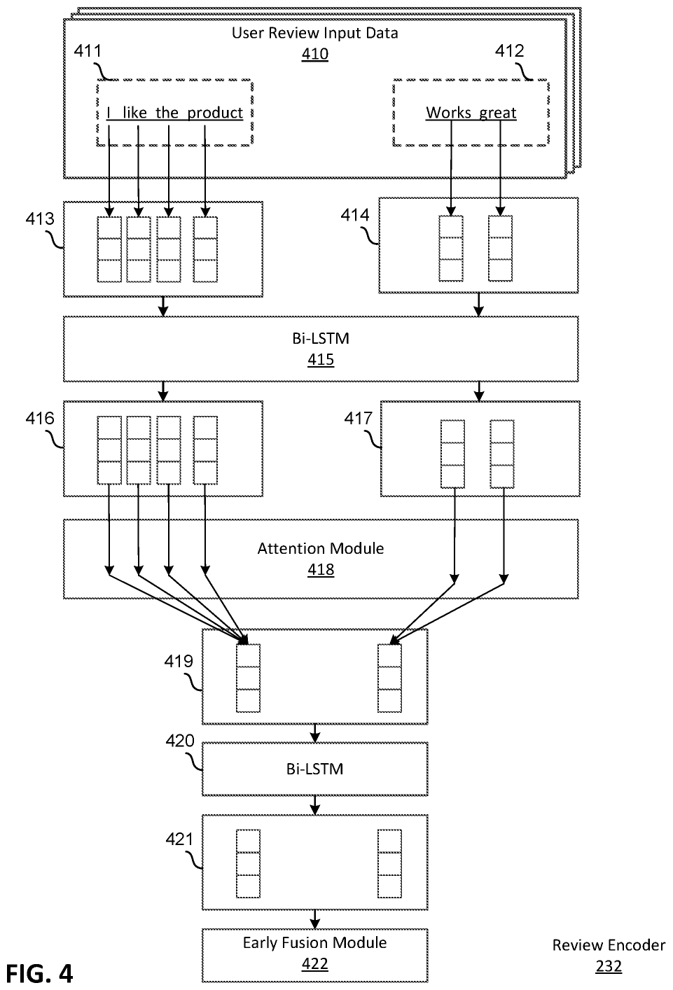

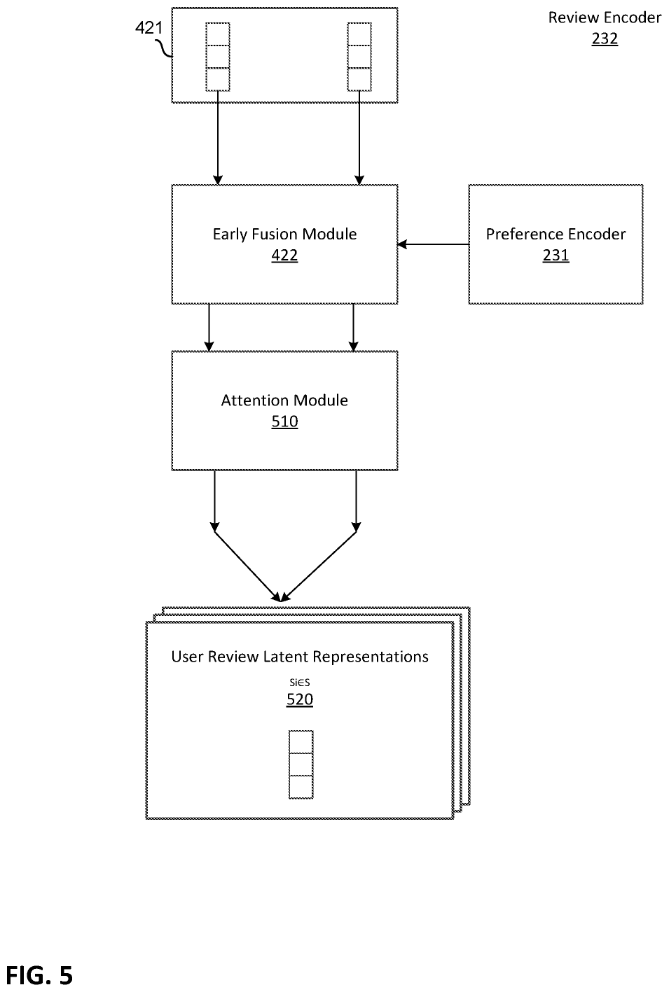

Data from implicit feedback databased 210 and user review database 220 may be passed into encoders 230 where the preference data and reviews are encoded into abstract representations. Specifically, preference data from the implicit feedback database 210 are encoded by the preference encoder 231 into a set of preference feature vectors, and the reviews stored in user review database 220 are encoded by the review encoder 232 into a set of review feature vectors. Each encoder in the encoders 230 comprises multiple neural network layers that transform the input data into abstract feature vectors, which are used as input for subsequent neural network layers. The preference encoder 231 is discussed in further details in accordance with FIG. 3 and the review encoder 232 is discussed in further details in accordance with FIGS. 4-5.

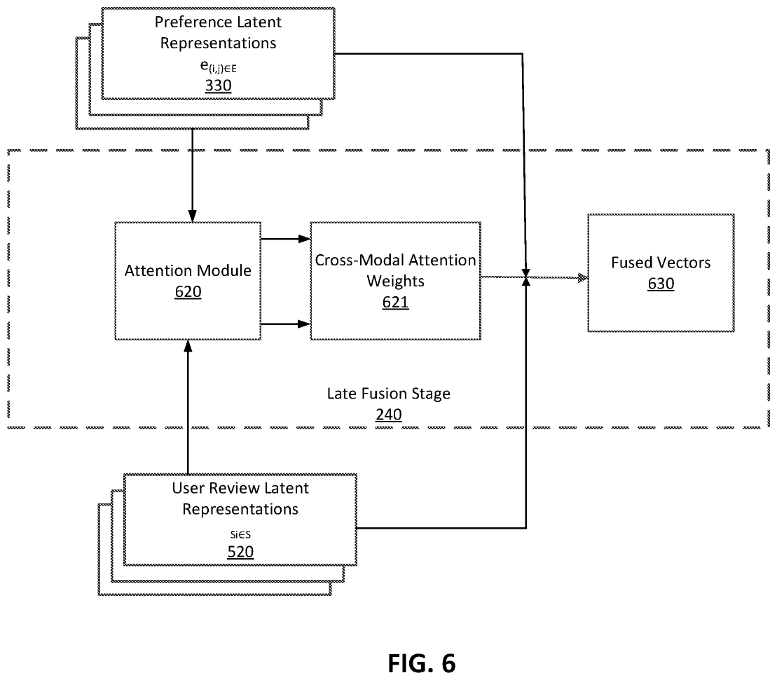

Continuing with the discussion of FIG. 2, the preference feature vectors outputted from the preference encoder 231 and the review feature vectors outputted from the review encoder 232 may be fused by a late fusion stage 240 that aggregates the two sources of inputs in a meaningful way by using an attention mechanism. As the preference feature vectors and the review feature vectors are each encoded by a different encoder, the two sets of representations are each in a different latent space, where a latent space may refer to an abstract multi-dimensional space containing feature values that cannot be interpreted by human beings directly, but rather are inferred based on input data. Stated in a different way, each set of latent representation may provide different contribution as input of subsequent neural network layers towards final prediction, and a simple concatenation of the two sets of representation may be inadequate. Therefore, the late fusion stage 240 leverages an attention mechanism that is trained to decide how much weight is given to each of the review representation and the preference representation when combining the two sources of input. The late fusion stage 240 outputs a set of fused feature vectors that contains information from both user reviews and user preferences. The late fusion stage 240 is discussed in further details in accordance with FIG. 6.

The fused feature vectors outputted from the late fusion stage 240 are passed into decoder 250, and specifically, into a preference decoder 251 for generating likelihood scores indicating likelihoods of each user u interacting with each item v. The preference decoder 251 may comprise two or more feedforward neural networks for processing input data. For example, a feedforward neural network may be a multilayer perceptron (MLP) with at least one hidden layer of nodes, where each node may be associated with a weight that is trained and optimized during a training process. During the training process, the weights (or parameters) are optimized through a backpropagation process that aims to minimize a reconstruction error by adjusting (e.g. training) the parameters. The preference decoder 251 may reconstruct preference matrix by generating likelihood scores, which may be used to make predictions such as generating a list of recommended items for the user. The generated likelihood scores indicate how likely each user u may interact with each item v.

In one embodiment, the predictions generated by the preference decoder 251 are optimized during the training process to reduce popularity bias. The preference decoder 251 may be trained in conjunction with an NCE (noise contrastive estimation) decoder to increase the likelihood of observed interactions and minimize the effect of popularity bias. Further description of a joint training process of the preference decoder 251 and an NCE decoder is discussed in further details in accordance with FIG. 7.

The trained prediction model 290 may generate outputs 260, such as a list of recommendations for a user based on the likelihood scores outputted from the preference decoder 251. In one embodiment, the list of recommendations may comprise items that are associated with a likelihood score higher than a pre-determined threshold. In one embodiment, the outputs 260 may include likelihood scores for each user-item pair, that is, for each user, the model generates a likelihood score for each item indicating a likelihood that the user may interact with the item. In another embodiment, the outputs 260 do not include a likelihood score for items that the user has interacted with previously, because the neural network model 290 may be pre-configured to only generate recommendations for items that the user has not interacted with previously.

FIG. 3 illustrates an exemplary architecture of a preference encoder 231, in accordance with one embodiment. In FIG. 3, the implicit feedback data 310 illustrates one exemplary input matrix stored in the implicit feedback database 210, the implicit feedback data 310 containing user-item interaction information. Each row of the implicit feedback data 310 contains a user's interaction information with each item v₁, v₂, . . . , vₘ, and similarly, each column of the implicit feedback data 310 contains interaction information between every user u₁, u₂, . . . , uₙ with one particular item. Each row of the implicit feedback data 310 may be expressed as R[u, :], and each column may be expressed as R[:, v]. In the embodiment illustrated in FIG. 3, the implicit feedback data 310 is a matrix with 1's indicating that there is a positive interaction between a user-item interaction. In an example, the rating matrix is a Boolean value of zero or one, in which a one represents a preference or an interaction of a user with a content item, and a value of zero represents either no preference or no interaction with the content item. In other embodiments, the ratings may have different ranges. Since the number of users and items may be significantly large, and ratings may be unknown for many users and items, the implicit feedback data 310 is, in general, a high-dimensional sparse matrix.

The implicit feedback data 310 are passed into a feedforward neural network 320 for feature extraction and embedding. The feedforward neural network 320 may include two (or more) MLPs (multilayer perceptron), each MLP containing at least one hidden layer of nodes. Each node may be associated with a weight (or parameters) that are trained during a training process. Nodes between each hidden layers are connected using a nonlinear activation function. In one embodiment, the feedforward neural network 320 may be trained using a supervised learning technique that minimizes the difference between ground truth and reconstruction values. The feedforward neural network 320 may output preference latent representations 330, which are vector embeddings of low dimension latent representations for implicit feedback data 310. The low dimensional latent representations include information abstracted from the implicit feedback data 310. The outputted preference latent representations 330 are passed to the late fusion stage 240, which is discussed in FIG. 6.

FIG. 4 illustrates an exemplary embodiment of a portion of a review encoder 232 including a plurality of neural network layers in the review encoder 232. The review encoder 232 takes the user review input data 410 such as reviews 411 and 412 as input. The reviews 411 and 412 may be tokenized into tokens (e.g. terms or words without spaces or punctuations). For example, review 411 “I like the product.” may be tokenized into four tokens including [“I”, “like”, “the”, “product”] and each token is further embedded into latent representations 413 and 414 through one or more word embedding algorithms such as GloVe (Global Vectors for Word Representation.) To further capture contextual information, each sequence of embedded token feature vectors is passed through a Bi-LSTM 415 (Bidirectional Long Short-Term Memory), which extracts both forward and backward information about the sequence of token feature representations. Specifically, for each token t, the Bi-LSTM further embeds information related to both the token in front of the token t and after the token t into the latent representation of token t. The outputted latent representations 416 and 417 may be referred to as contextual embeddings \hat{t}₁, \hat{t}₂, . . . , \hat{t}_{S} because the Bi-LSTM 415 is trained to embed information related to the neighboring tokens of each token into the latent representations for each token t. The Bi-LSTM 415 may output contextual latent representations 416 and 417, each corresponding to review 411 and 412.

After contextual encoding through the Bi-LSTM 415, the contextually latent vectors 416 and 417 are passed through an attention module 418 for further embedding. The attention module 418 may determine weights for each token feature vector, where the weights indicate how much attention to focus on relevant tokens within each review. Specifically, attention weights for each token and the attention weight for each review may be determined based on the following algorithm:

$${γ}_{k} = {W}_{2} tanh ( {W}_{1} {\hat{t}}_{k} + {b}_{1} ) + {b}_{2}$$

$${a}_{k} = \frac{exp ( {γ}_{k} )}{{\sum }_{{k}^{′} = 1}^{\vert S \vert} exp ( {γ}_{{k}^{′}} )}$$

$$a = {\sum }_{k = 1}^{\vert S \vert} {a}_{k} \cdot {\hat{t}}_{k}$$

where W's are attention weights, b's are biases, aₖ is the attention coefficient for each token embedding, and a is the summarized feature vector for a review by aggregating the word token embeddings based on determined attention weights. Repeating this process for every user review S₁, S₂, . . . , S_{N}, the attention module 418 may determine corresponding attention-fused feature vectors 419 a₁, a₂, . . . , a_{N} for each review. Each attention-fused feature vector 419 may be viewed as a summarization for the review S based on an attention-based aggregation of token feature vectors in each review.

Similar to contextualizing word tokens in Bi-LSTM 415, another Bi-LSTM 420 may be applied over the generated attention-fused feature vectors 419. The Bi-LSTM 420 may output a latent vector representation for each review to get attention-fused contextualized review vectors 421. The contextualized review vectors 421 capture both global context across reviews and specific word-level information from each review. The embedded review feature vectors may be further passed through an early fusion module 422, which is discussed in further details in FIG. 5.

FIG. 5 illustrates an exemplary embodiment of a set of additional neural network layers in a review encoder 232, the set of additional neural network layers including an early fusion module 422. In FIG. 5, the contextualized review vectors 421 are passed into an early fusion module 422, which incorporates preference data into each individual review before all the reviews for a user are combined into one user review latent representation 520. Specifically, the early fusion module 422 may conduct a concatenation of each contextualized review vector 421 with preference latent representation 330 generated by the preference encoder 231. The concatenated feature vectors are then passed through another attention module 510 to allow the reviews S₁, S₂, . . . , S_{N} focus on the most relevant reviews. The attention module 510 may determine attention weights for each review feature representation, and the most relevant reviews may receive the most significant attention weights. For example, the attention module 510 may determine attention weights using the following algorithm:

$${β}_{n} = {W}_{4} tanh ( {W}_{3} [ {\hat{a}}_{n} ; {e}_{u} ] + {b}_{3} ) + {b}_{4}$$

$${ℊ}_{n} = \frac{exp ( {β}_{n} )}{{\sum }_{{n}^{′} = 1}^{N} exp ( {β}_{{n}^{′}} )}$$

$${s}_{u} = {\sum }_{n = 1}^{N} {ℊ}_{n} \cdot {\hat{a}}_{n}$$

where W's are attention weights, b's are biases, gₙ is the attention coefficient for each attention-fused contextualized review vector 421, and Sᵤ is the summarized feature vector for all the reviews generated by a user by aggregating the review embeddings based on determined attention weights. The attention weights are then used to aggregate the reviews together to form a user review latent representations 520 which includes summarized information from all the reviews S₁, S₂, . . . , S_{N} generated by a user. The review latent representations 520, along with the preference latent representations 330 are passed through a late fusion stage 240 for a final stage of fusion.

FIG. 6 illustrates an exemplary embodiment of a late fusion stage 240 that aggregates information from user reviews and user preference into fused latent representations. To this step, the preference encoder 231 has generated preference latent representations 330 and the review encoder 232 has generated user review latent representations 520. Each of the preference latent representations 330 and the user review latent representations 520 may be mapped into different latent spaces (e.g. with the latent vectors of different dimensions). The latent spaces for preference and review encoders may differ and the contribution associated with each latent representation towards the final prediction may vary. Therefore, simply concatenating the two representations together to generate fused vector representations may be inadequate. To ensure that the information from two representations is properly combined, the two sets of representations are passed through a late fusion stage 240.

The late fusion stage 240 may aggregate information from both resources and may output fused vectors 630 by using another attention module 620. In one embodiment, the late fusion stage 240 may first map each representation 330 and 520 to a common latent space. After the feature representations are mapped into the same latent space, attention module 620 may apply an attention mechanism in the space shared by the two feature representations to fuse the two sets of feature representations. The preference latent representations 330 and user review latent representations 520 are passed into an attention module 620, which generates cross-modal attention weights 621. The cross-modal attention weights 621 represent the weights to assign to each modality (e.g. the two sources of input) and the attention weights are further used to combine information from the two modalities. In one embodiment, the cross-modal attention weights 621 are determined based on the following algorithms:

αₛ=W₅ tan h(W₆sᵤ+b₆)+b₅

αₑ=W₅ tan h(W₇eᵤ+b₇)+b₅

\tilde{α}ₛ, \tilde{α}ₑ=softmax(αₛ, αₑ)

vₛ=Wᵥ tan h(W₆sᵤ+b₆)+bᵥ

vₑ=Wᵥ tan h(W₇eᵤ+b₇)+bᵥ

v_{fused}=\tilde{α}ₛ·vₛ+\tilde{α}ₑ·vₑ

where W's are attention weights and b's are biases, αₛ and αₑ are attention coefficients for each modality, vₛ and vₑ are the two sets of feature representations with transformation, and v_{fused} is the fused vectors 630 which are final user representations that combine information from both modalities. The two transformed feature representations vₛ and vₑ share attention weights Wᵥ and biases bᵥ, and as a result, the two representations are mapped to a common space before fusion. Similarly, αₛ and αₑ share attention weights W₅ and b₅, and as a result, the attention coefficients are mapped to the same space. The cross-modal attention weights 621 may be further passed through a softmax function for normalization such that the attention weights are mapped into an interval [0, 1]. The late fusion stage 240 outputs fused vectors 630, which are passed through the preference decoder 251 for making predictions in a deployment process. In a training process, the fused vectors 630 are passed through a preference decoder and an NCE decoder independently, while the training process is a joint training process such that errors from both the preference decoder and the NCE decoder are used for optimization in backpropagation. The training process of the neural network model 290 is discussed in further details in accordance with FIG. 7.

### Training Process of the Neural Network Model

FIG. 7 illustrates an exemplary process for training a prediction model 790 for generating personalized recommendations using information from implicit feedback and user reviews. The prediction model 790 may be configured as one or more neural network models. The recommendation system 130 trains the prediction model 790 using a set of training content x_{(i,j)∈T} from a training set T from the implicit feedback database 710, and using a set of training content y_{(i,j)∈R} from a training set R from the user review database 720. The prediction model 790 includes a set of parameters, and the prediction model 790 is trained by iteratively updating the parameters to reduce a loss function based on the training content x_{(i,j)∈T} and y_{(i,j)∈R}.

In the embodiment illustrated in FIG. 7, the prediction model 790 includes the preference management module 211 for generating implicit feedback data and the generated implicit feedback data are stored in the implicit feedback database 210. The user review database 220 stores textual reviews generated by users. In one embodiment, functionalities of the preference management module 211, the implicit feedback database 210, and the user review database 220 are the same as the functionalities of the preference management module 211, the implicit feedback database 210, and the user review database 220, as described in accordance with FIGS. 2-3.

In one embodiment, the training content includes multiple instances of training instances, where each training instance i includes input data and labels that represent the types of data the prediction model is targeted to receive and predict. The training data may be split into three data sets, namely, a training dataset for learning the set of parameters, a validation dataset for an unbiased estimate of the model performance, and a test dataset for evaluating final performance. In one embodiment, the input training data for each user u includes a vector containing implicit feedback for the user and a list of items v₁, v₂, . . . , vₘ, and a list of reviews S₁, . . . , Sₚ generated by the user u.

Different from the input data for the deployment process, the training process of the prediction model 790 makes predictions using labeled training contents that are associated with preference data. For example, as described in connection with the deployment process in FIG. 2, the prediction model predicts, based on the reviews and observed interactions associated with a user, how likely the user may interact with items for which observed interactions are not available. However, in a training process, predictions are made for items that are associated with observed preference data. These data records may also refer as labeled data as the ground truth is known and labeled in the training data.

Specifically, for a user u, a labeled training record may be a list of reviews generated by the user, and a list of items known to have positive or negative observed interactions with the user. As a concrete example, a user u may be associated with the following data: user-generated reviews S₁ and S₂, observed interactions with items v₁, v₂, v₃, and missing interactions for items v₄ and v₅. For the given example, input data for a deployment (or prediction process) may include reviews S₁ and S₂, observed interactions with items v₁, v₂, v₃, and the prediction model predicts likelihoods of interaction for items v₄ and vₛ. In a training process, the input training data may include reviews S₁ and S₂, observed interaction with items v₁, v₂, and the prediction model in the training process may predict a likelihood that the user will interact with item v₃. In one embodiment, the training data include labels (or known ground truth) for determining a reconstruction error for backpropagation. The error is determined based on the difference between prediction results and the known ground truth. The determined error and gradients derived based on the error are then backpropagated all the way to the embedding layers of the prediction model 790 for updating parameters.

Continuing with the training process illustrated in FIG. 7, the training data are inputted into the encoders 230, which include the preference encoder 231 and the review encoder 232. Each encoder transforms the input data into latent representations. The functionalities of the encoders 230, preference encoder 231, and review encoder 232 are the same as those described for the encoders 230, preference encoder 231 and review encoder 232 in FIG. 2. The encoders 230 may generate embedded latent representations for preference input data and user review input data. The outputted latent representations are further fused by the late fusion stage 240, which performs the same functionalities as the late fusion stage 240 illustrated in FIG. 6.

The fused vectors outputted from the late fusion stage 240 are passed into decoders 750, including a preference decoder 251 and an NCE decoder 752. Different from the deployment process illustrated in FIG. 2, the training process includes an additional NCE decoder 752 for decreasing popularity bias when making predictions. The fused vectors are passed through each decoder independently for generating reconstruction predictions and errors.

Specifically, the NCE decoder 752 may help to increase the likelihood of observed interactions, while minimizing the likelihood for negative samples (e.g. items that are missing observed interactions associated with a user but are popular among the items) drawn from a popularity-based noise distribution. In one embodiment, the popularity-based noise distribution q may be modeled using the following objective function for minimizing popularity bias:

$${argmin}_{θ} - {\sum }_{i} {r}_{u , i} [ log p ( {r}_{u , i} = 1 ) + {E}_{q ( {i}^{′} )} [ log p ( {r}_{u , {i}^{′}} = 0 ) ] ]$$

where r_{u,i} is the interaction between user u and item i, and θ is a set of parameters to be optimized. When the θ is optimized, the popularity bias should be minimized. The probabilities in the expression above p(r_{u,i}=1) and p(r_{u,i}, =0) are modelled using a sigmoid function:

p(r_{u,i}=1)=σ(\tilde{r}_{u,i}; θ)

p(r_{u,i}=0)=1−σ(\tilde{r}_{u,i}; θ)

where \tilde{r}_{u,i} is the reconstructed preference data, and σ is the sigmoid function. Combining the previous equations and solving for the reconstructed matrix \tilde{R} (e.g. \tilde{r}_{u,i} or reconstructed preference data for each user-item pair), the following equation may be used:

$$\frac{\partial ℓ}{\partial {\tilde{r}}_{u , i}} = σ ( - {\tilde{r}}_{u , i} ) - \frac{\vert {r}_{: , i} \vert}{{\sum }_{{i}^{′}} \vert {r}_{: , {i}^{′}} \vert} σ ( {\tilde{r}}_{u , i} )$$

where l is the loss in the objective function above for minimizing popularity bias. Solving the equation above, the optimal solution for observed interaction is:

$${r}_{u , i}^{*} = log \frac{{\sum }_{{i}^{′}} \vert {r}_{: , {i}^{′}} \vert}{\vert {r}_{: , i} \vert} ∀ {r}_{u , i} = 1$$

and for unobserved interactions, the optimal solution is expressed as:

r_{u,i}:=0 ∀r_{u,i}=0

The optimal solutions increase the likelihood of observed interactions while minimizing popularity bias.

Specifically, to this point, the labels or ground truth for both the NCE decoder 752 and the preference decoder 251 are ready for calculation of loss based on loss functions. The r_{u,i}* may be used as the optimal solution for calculating an error term for the NCE decoder 752 predictions and the labels from the training data may be used as the ground truth for calculating error term for the preference decoder 251. The error terms from each decoder are combined and the gradients are backpropagated through the entire architecture of the predicting model 790 to review token embedding layers (e.g., encoders 230) that are also updated during training. During the prediction process, only the parameters from the preference decoder 251 are used to make predictions. In particular, the loss function (objective function) for the preference decoder 251 is optimized with the mean squared error (MSE) reconstruction objective:

Lᵤ^{MSE}=∥rᵤ; −h_{MSE}(v_{fused})∥₂

which is a Euclidean distance between the ground truth and the prediction generated from the preference decoder 251. Similarly, the loss function to optimize for the NCE decoder 752 is expressed as:

Lᵤ^{NCE}=∥r_{u,;}*h_{NCE}(v_{fused})∥₂

which is a Euclidean distance between the optimal solution and the prediction generated from the NCE decoder 251. The loss from the preference decoder 251 and the NCE decoder 752 are combined and gradients 770 are derived based on the combined loss. Specifically, the combined error term is a linear combination of the error term from the NCE decoder, the error term from the preference decoder, and a regularization term, which may be expressed as follows:

$$L = {\sum }_{u} {L}_{u}^{MSE} + {L}_{u}^{NCE} + λ {‖ θ ‖}^{2}$$

The gradients 770 of the loss function L are backpropagated through the whole model back to encoders 230 for updating each parameter in the autoencoder 700. The process may be iteratively performed multiple times until a predetermined criteria is met. A predetermined criteria may be a convergence criteria such as when the error term is below a predetermined threshold or the decrease in error term for each iteration is below a predetermined threshold.

In one embodiment, the recommendation system 130 trains the prediction model by repeatedly iterating between a forward pass step and a backpropagation step. During the forward pass step, the prediction system 130 generates prediction by applying the prediction model to user review data and preference data. The recommendation system 130 determines a loss function that indicates a difference between the estimated outputs 760 and actual labels for the plurality of training instances. During the backpropagation step, the recommendation system 130 repeatedly updates the set of parameters for the prediction model by backpropagating error terms obtained from the loss function. This process is repeated until the loss function satisfies predetermined criteria.

During the training process, the recommendation system 130 may train the prediction model by adjusting the architecture and set of parameters to accommodate additional input data as needed, for example, by increasing the number of nodes in the input layer and the number of parameters. During the forward pass step, the recommendation system 130 generates the estimated outputs 760 by applying the prediction model to the additional input data in the training data in addition to data extracted from training data. The recommendation system 130 determines the loss function and updates the set of parameters to reduce the loss function. This process is repeated for multiple iterations and the training process is completed when the predetermined criteria is reached. After the training process has been completed, the trained parameters may be stored and the recommendation system 130 can deploy the trained prediction model to receive data including user reviews and user preference to generate predictions how likely a user may interact with items without preference information.

### Additional Considerations

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A recommendation model stored on a non-transitory computer readable storage medium, the recommendation model associated with a set of parameters, and configured to receive a set of features associated with a user and a content item and to output a likelihood that the user will interact with the content item, wherein the recommendation model is manufactured by a process comprising:
obtaining a training dataset that comprises:
implicit user feedback data, the implicit user feedback data including data characterizing interactions between a plurality of users including the user, and a plurality of content items that were presented to the plurality of users, the implicit user feedback data including labels indicating whether the plurality of users interacted with the plurality of content items; and
user review data, wherein the user review data includes texts from one or more reviews generated by the plurality of users, the one or more reviews associated with at least one content item of the plurality of content items;
for a two-headed attention fused autoencoder associated with the set of parameters, wherein the two-headed attention fused autoencoder comprises an encoder coupled to a preference decoder and to a noise contrastive estimation (NCE) decoder, repeatedly iterating the steps of:
generating a set of fused features based on the training dataset using the encoder;
passing the set of fused features through the noise contrastive estimation (NCE) decoder and the preference decoder;
obtaining a first error term obtained from a first loss function associated with the NCE decoder;
obtaining a second error term obtained from a second loss function associated with the preference decoder;
backpropagating a third error term to update the set of parameters associated with the recommendation model, wherein the third error term is calculated based on the first error term generated from the NCE decoder and the second error term generated from the preference decoder;
stopping the backpropagation after the third error term satisfies a predetermined criteria; and
storing a subset of the set of parameters on the computer readable storage medium as a set of trained parameters of the recommendation model, the subset of the set of parameters associated with the encoder and the preference decoder.

2. The recommendation model of claim 1, wherein the encoder of the two-headed attention fused autoencoder comprises:
a preference encoder that takes the implicit user feedback data as input, and outputs a set of embedded preference feature vectors characterizing the implicit user feedback data.

3. The recommendation model of claim 2, wherein the encoder of the two-headed attention fused autoencoder further comprises:
a review encoder that takes the user review feedback data as input and outputs a set of embedded review feature vectors, wherein the set of embedded review feature vectors are generated based on the one or more reviews.

4. The recommendation model of claim 3, wherein the review encoder further comprises a word attention module that assigns attention weights to each word embedding in a review, the word attention module generating a review summarization feature vector for each review.

5. The recommendation model of claim 3, wherein the generation of the set of embedded review feature vectors further comprises, concatenating a set of review representation with a set of preference representation.

6. The recommendation model of claim 5, wherein the generation of the set of embedded review feature vectors further comprises:
generating review attention weights by inputting the set of embedded review feature vectors into a review attention module;
generating a summarized review feature vector for each user, the summarized review feature vector summarizing one or more reviews generated by the user.

7. The recommendation model of claim 3, wherein the set of embedded review feature vectors are generated by using one or more bidirectional LSTM (long short-memory) neural networks.

8. The recommendation model of claim 3, wherein the process further comprises:
generating modal attention weights based on the set of embedded preference feature vectors and the set of embedded review feature vectors; and
generating the set of fused features by aggregating the set of embedded preference feature vectors and the set of embedded review feature vectors based on the modal attention weights.

9. The recommendation model of claim 1, wherein the NCE decoder comprises one or more feedforward neural network layers, wherein the NCE decoder reduces popularity bias by increasing the likelihood that the user will interact with the plurality of content items based on the implicit user feedback data.

10. The recommendation model of claim 1, wherein the preference decoder comprises one or more feedforward neural network layers, wherein the preference decoder generates a plurality of probabilities corresponding to the plurality of content items, the plurality of probabilities indicating likelihoods that the user will interact with the plurality of content items.

11. The recommendation model of claim 1, wherein the third error term is calculated as a linear combination of the first error term from the NCE decoder and the second error term from the preference decoder.

12. A method of selecting a subset of items from a plurality of candidate items for recommendation to a user, the method comprising:
generating a set of probabilities associated with the plurality of candidate items using the content selection model of claim 1, the set of probabilities indicating likelihoods that the user will interact with the plurality of candidate items; and
selecting the subset of items from the plurality of candidate items for display to the user based on the set of probabilities associated with the candidate items.

13. A method of selecting a subset of items from a plurality of candidate content items for recommendation to a user using the trained recommendation model of claim 1, the method comprising:
obtaining a dataset that comprises:
implicit user feedback data, the implicit user feedback data including data characterizing interactions between a plurality of users including the user, and a plurality of content items that were presented to the plurality of users, the implicit user feedback data including labels indicating whether the plurality of users interacted with the plurality of content items; and
user review data, wherein the user review data include texts from one or more reviews generated by the plurality of users, the one or more reviews associated with at least one content item of the plurality of content items;
generating, by the trained recommendation model, a set of preference vectors by feeding the implicit user feedback data into a preference encoder;
generating, by the trained recommendation model, a set of review vectors by feeding the user review data into a review encoder;
generating a set of fused vectors by aggregating the set of preference vectors and the set of review vectors;
generating, by the trained recommendation model based on the set of fused vectors, a set of likelihoods, for each candidate content item of the set of candidate content items, that the user will interact with each candidate content item; and
selecting the subset of items from the plurality of candidate items for display to the user based on the set of likelihoods associated with the set of candidate content items.

14. A recommendation model that includes a two-headed attention fused autoencoder, the model comprising:
a first input branch comprising a preference encoder that is trained to generate a set of preference feature vectors characterizing a set of implicit user feedback data;
a second input branch comprising a review encoder that is trained to generate a set of review feature vectors characterizing a set of user review data;
one or more fusion stages that aggregate the set of preference feature vectors with the set of review feature vectors; and
an output branch that generates a set of likelihood scores for a set of candidate content items, the set of likelihood scores indicating how likely a user will interact with each of the set of candidate content items, wherein the recommendation model is trained with an additional output branch using a set of training data.

15. The recommendation model of claim 14, wherein the review encoder further comprises a word attention module that assigns attention weights to each word embedding in a review, the word attention module generating a review summarization feature vector for each review.

16. The recommendation model of claim 14, wherein the one or more fusion stages comprise an early fusion stage and a late fusion stage.

17. The recommendation model of claim 16, wherein the early fusion stage comprises:
generating a set of concatenated feature vectors by concatenating a set review representations with a set of preference representations;

18. The recommendation model of claim 17, wherein the early fusion stage further comprises:
generating review attention weights by inputting the concatenated feature vectors into a review attention module; and
generating a summarized review feature vector for each user based on the review attention weights, the summarized review feature vector summarizing all the reviews generated by the user.

19. The recommendation model of claim 14, wherein the additional output branch comprises an NCE decoder that reduces popularity bias by increasing a likelihood that the user will interact with the set of candidate content items based on the set of implicit user feedback data.

20. The recommendation model of claim 14, wherein the review encoder comprises one or more bi-directional LSTM (long short-term) neural networks.
